(19) United States
(12) Patent Application Publication
(10) Pub. No.: US 2025/0363145 A1
(43) Pub. Date: Nov. 27, 2025

(54) Intelligent Communication Secretary System

(71) Applicant: Barkingdog Technology Inc., Kaohsiung City (TW)

(72) Inventor: Guan-Wen XU, Kaohsiung City (TW)

(21) Appl. No.: 19/213,087

(22) Filed: May 20, 2025

(30) Foreign Application Priority Data
May 23, 2024 (TW) 113119205

(51) Int. Cl. G06F 16/3329; G06F 16/3332

(52) U.S. Cl. CPC G06F 16/33295; G06F 16/3332

(57) ABSTRACT

An intelligent communication secretary system, applicable to being connected to a first communication system and including an intelligent interaction unit and a database unit. The intelligent interaction unit includes an intelligent interaction module and an interaction outline generation module. The database unit includes a knowledge storage module and a historical interaction storage module. The intelligent interaction module can interact with a user by using the first communication system. The knowledge storage module stores interaction knowledge for the intelligent interaction module to interact with the user and generate a first interaction content. The historical interaction storage module stores a historical interaction content. The interaction outline generation module analyzes the historical interaction content and generates interaction outline data.

### TECHNICAL FIELD

The present disclosure relates to a communication system, and in particular, to an intelligent communication secretary system that may integrate a plurality of communication modules and generate outline data.

### BACKGROUND

In a competitive market, enterprise services occupy a very important role. Good customer service is the key to enterprise success. For example, the customer services (customer service works) include assisting customers in solving problems, acting as a bridge for communication between the customers and a company, identifying disadvantages of the company and optimizing services to improve the loyalty of the customers to the company, achieving mutual benefits between the company and the customers through services, accepting inquiries from the customers, answering doubts from the customers, or institutions undertaking the customer service works, and so on. Services may create value for the customers and make them receive support and assistance they need.

Existing customer service channels include early telephone customer services, gradual network messages, or delivery of information via e-mail, and now are more advanced to interact with the customers through intelligent virtual customer services (AI). AI can not only understand customer demands but also answer enterprise-related knowledge, thereby improving the efficiency of customer services. Although the intelligent virtual customer services have been able to gradually replace part of manual efforts, a staff is still required to work together with computers in actual operation to provide a better customer service experience.

In addition, video meetings, also known as web meetings, allow staffs in an organization to communicate on computers, smart devices or remote joint work tools via a video-enabled platform. During dealing with work, such communication tools may assist remote employees in contacting with each other and enable them to carry out immediate joint work. Certainly, video meeting software may also be used for communication between an enterprise and customers. An enterprise meeting usually involves a great number of contents. Although the entire contents of the meeting may be recorded through audio and video recording, data are scattered and cumbersome, and it takes a lot of time to organize key points of the meeting.

Whereas in the discussion process of the meeting, a meeting participant usually needs to show some information and pictures, or needs to refer to some related professional knowledge. In this case, unless the meeting participant has already prepared, it will take a lot of time to retrieve files, which not only wastes time for the meeting but also makes other participants or customers displeased.

Additionally, there are numerous options of existing communication software or video conference software, but different communication software is not common in use. For instance, communication modules only have a function of making calls. For example, an existing telephone only provides a dialog function, after the enterprise has a conversation with a customer, a customer service staff can only explain contents of this call one by one based on items of service, the customer has to record key points of the call by himself, and when the enterprise needs to provide related data, such data have to be mailed separately or served by a dedicated person.

As can be seen from the above description that the existing communication software or video meeting software has the following disadvantages when used.

### 1. It Takes a Lot of Time to Organize Key Points of a Dialog.

The existing communication software or video meeting software only provides transmission of videos or voices, requiring users to manually record key points of the conversation. Although meeting or customer service data may be stored in an audio recording or video recording manner, it is necessary to repeatedly watch or listen to the stored data later in order to organize the key points of the conversation, which will consume a lot of time.

### 2. Contents Cannot be Accessed or Retrieved at any Time.

The existing communication software or video meeting software cannot directly record contents of a voice conversation or a video meeting in a verbatim transcript manner, cannot provide the process of the voice conversation or the video meeting through a text, and also cannot directly obtain audio and video data of a corresponding segment, which makes it impossible for a user to retrieve and review the interactive contents at any time.

### 3. It is Difficult to Provide Unprepared Data.

The existing network communication software or video meeting software can only output data prepared by the user in advance. When the user needs to provide additional videos or pictures, or the user is desired to refer to provisions in enterprise organization regulations or related articles, these data have to be accessed in a stored folder, and the network communication software or the video meeting software cannot proactively provide the user with the data they need.

### 4. Data Cannot be Transferred Across Platforms.

In an existing communication technology, after the communication modules interact, only the same communication modules can be used for providing data. If the communication modules cannot provide related data, the enterprise has to provide services separately by assigning a dedicated person or by mail, and cross-platform interaction is prohibited. Both the customer and the service staff can only interact by using a single mode. For example, in a short message service system, both the customer and the customer service staff can only interact through a text and cannot communicate in any other way.

### 5. It is not Easy to Provide Professional Knowledge.

Generally, junior customer service staffs not only have a weak ability to deal with customers, but also lack professional knowledge. They are unable to provide the professional knowledge for the customers or give them appropriate answers, resulting in a poor service experience for the customers and their inabilities to obtain information they need.

### 6. Real-Time On-Site Services Cannot be Provided.

Among interaction knowledge or professional knowledge stored in general virtual customer services, only known data can be provided for a customer, and it is difficult to address real-time, on-site situations. The general virtual customer services do not have an ability to be connected to a detection device, resulting in an inability of the general virtual customer services to serve for the customer based on actual on-site conditions.

Therefore, how to set up a system that may assist the user in automatically recording and organizing the key points related to the dialog, and proactively providing corresponding professional knowledge or data, as well as capable of using multiple communication platforms for services is an urgent objective that those skilled in the relevant art need to strive for.

### SUMMARY OF THE INVENTION

Aspects of the disclosure provide an intelligent communication secretary system. The intelligent communication secretary system is applicable to being connected to a first communication system. The first communication system has a first interaction interface specific to a user comprising an intelligent interaction unit and a database unit.

The intelligent interaction unit comprises an intelligent interaction module connected to the first interaction interface and an interaction outline generation module connected to the intelligent interaction module.

The database unit comprises an account storage module connected to the intelligent interaction module, a knowledge storage module connected to the intelligent interaction module, a historical interaction storage module connected to the intelligent interaction module, and an outline data storage module connected to the intelligent interaction module. The account storage module is configured to store account data related to the first interaction interface in such a way that the intelligent interaction module can interact with the user by using the first interaction interface. The knowledge storage module is configured to store interaction knowledge of interaction with the user for the intelligent interaction module to interact with the user and generate a first interaction content. The historical interaction storage module is configured to store the first interaction content and make a same into a historical interaction content. The interaction outline generation module analyzes the semantics of the historical interaction content and generates interaction outline data based on key semantic points, which is stored in the outline data storage module.

The user inputs information into the intelligent interaction unit via the first interaction interface, the intelligent interaction module interprets the information entered by the user, retrieves relevant data from the database unit based on the interpretation, and the intelligent interaction module transmits the retrieval result back to the user through the first communication system.

In one embodiment, the intelligent communication secretary system is further connected to a second communication system, the intelligent interaction unit further comprises an account comparison module connected to the intelligent interaction module, the intelligent interaction module is connected to the second communication system, and the account comparison module obtains a comparison account from the second communication system and accesses to the account storage module for retrieval to confirm whether the first communication system has account data of a user of the second communication system thereby enabling the intelligent interaction module to interact with the user via the second communication system.

In one embodiment, the second communication system interacts with the user and generates a second interaction content, the historical interaction storage module stores the second interaction content and makes a same into a historical interaction content, and the intelligent interaction module outputs the interaction outline data stored in the outline data storage module from the first interaction interface of the first communication system.

In one embodiment, the second communication system has a second interaction interface, the intelligent interaction module is connected to the second interaction interface, and the intelligent interaction module uses the interaction knowledge stored in the knowledge storage module to interact with the user. The user inputs data through the second interaction interface, which transmits the data to the intelligent interaction module. The intelligent interaction module interprets the user's semantics and performs a retrieval from the database unit. The retrieval result is transmitted back to the user via the second interaction interface.

In one embodiment, the intelligent interaction unit further comprises a knowledge retrieval module connected to the intelligent interaction module, the knowledge retrieval module stores at least one keyword, which is used to analyze the interaction knowledge stored in the knowledge storage module to obtain at least one knowledge fragment in the interaction knowledge and at least one fragment position for retrieving the knowledge fragment, and the fragment position is used for the intelligent interaction module to quickly obtain the knowledge fragment.

In one embodiment, the interaction knowledge stored in the knowledge storage module is selected from one or a combination of a text content, a picture content, a voice content and an audio and video content, and the intelligent interaction module, based on the first interaction content of the first interaction interface, controls the knowledge retrieval module to access to the knowledge storage module or a network to retrieve the related text content, picture content, voice content and audio and video content and transmit a same to the second interaction interface.

In one embodiment, in a case that the interaction knowledge stored in the knowledge storage module is the voice content or the audio and video content, the knowledge retrieval module converts the voice content or the audio and video content into the text content first and then analyzes the text content to classify a same and obtain a knowledge fragment and a fragment position, and the fragment position is playback time of the voice content or the audio and video content.

In one embodiment, the intelligent interaction unit further comprises a staff interaction module connected to the intelligent interaction module, the staff interaction module provides a professional staff to interact with the user and generates a professional interaction content, the intelligent interaction module stores the professional interaction content in the historical interaction storage module and makes a same into a historical interaction content, and the intelligent interaction module learns and analyzes the historical interaction content and generates interaction knowledge stored in the knowledge storage module.

In one embodiment, the intelligent interaction unit further comprises a knowledge augmentation module connected to the intelligent interaction module, and the knowledge augmentation module is configured to augment the interaction knowledge in the knowledge augmentation module

In one embodiment, the intelligent interaction unit further comprises a calendar editing module connected to the intelligent interaction module, the database unit further comprises a calendar storage module connected to the intelligent interaction module, the calendar editing module analyzes data stored in the historical interaction storage module, extracts data related to a calendar and generates a calendar event, and the intelligent interaction module edits a calendar content in the calendar storage module based on the calendar event.

In one embodiment, the intelligent interaction module is further connected to a data detection device outputting detection data, the intelligent interaction unit further comprises a detection analysis module connected to the intelligent interaction module, the detection analysis module stores detection judgment knowledge and analyzes and judges the detection data, and the intelligent interaction module interacts with the user in the first communication system based on a judgment result of the detection analysis module

In one embodiment, intelligent interaction module is further connected to a decision output device for outputting a decision instruction, the database unit further comprises a permission storage module connected to the intelligent interaction module, and the permission storage module is configured to store an execution permission related to the decision instruction and set the execution permission of the decision instruction as a priority in such a way that the intelligent interaction module prioritizes execution of the decision instruction.

The present disclosure provides features in facilitating communication, whether through information exchange with customers or in meetings with other individuals. The intelligent interaction module is configured to analyze interaction data and generate interaction outline data, thereby enabling the enterprise or the customer to promptly understand the key points of the interaction. The account storage module stores account information associated with both the first communication system and the second communication system, allowing the intelligent interaction module to flexibly utilize and output corresponding data. Additionally, the calendar editing module is capable of automatically extracting calendar-related information from the interaction content and generating corresponding calendar entries.

### BRIEF DESCRIPTION OF THE DRAWINGS

FIG. 1 is a schematic diagram of module settings of an intelligent communication secretary system according to one embodiment of the present disclosure;

FIG. 2 is a schematic diagram of data transmission related to generating interaction outline data according to one embodiment;

FIG. 3 is a schematic diagram of data transmission related to using different interaction interfaces according to one embodiment;

FIG. 4 is a schematic diagram of data transmission related to retrieving a video according to one embodiment;

FIG. 5 is a schematic diagram of data transmission related to learning professional knowledge according to one embodiment;

FIG. 6 is a schematic diagram of assisting as a customer service staff according to one embodiment;

FIG. 7 is a schematic diagram of data transmission related to automatically generating a calendar according to one embodiment;

FIG. 8 is a schematic diagram of data transmission related to external device connection according to one embodiment; and

FIG. 9 is a schematic diagram of data transmission related to executing a decision instruction according to one embodiment.

### DETAILED DESCRIPTION OF THE EMBODIMENTS

The disclosure will now be described more fully hereinafter with reference to the accompanying drawings, in which embodiments are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

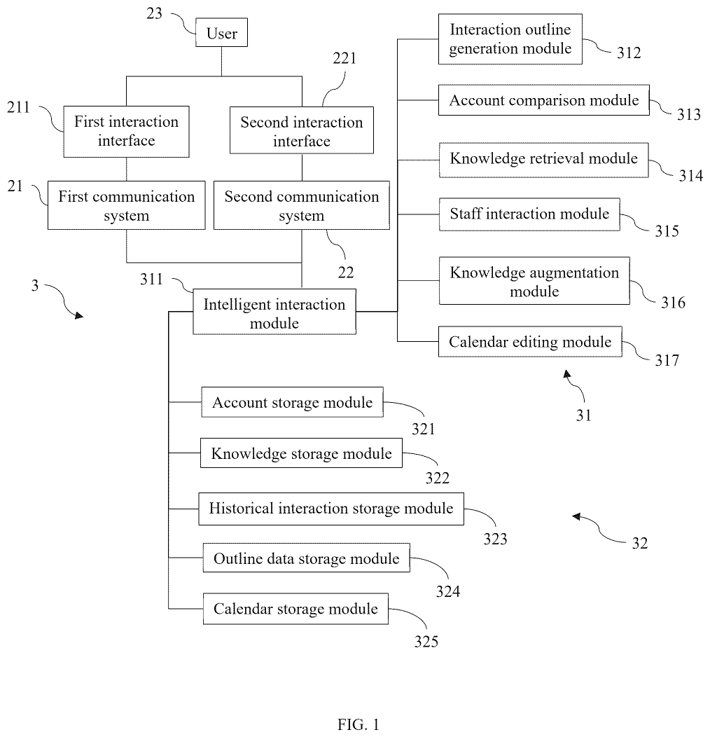

Reference is made to FIG. 1, which is an intelligent communication secretary system 3 according to one embodiment of the present disclosure. The intelligent communication secretary system 3 is applicable to be connected to a first communication system 21 and a second communication system 22. The first communication system 21 has a first interaction interface 211 specific to a user 23. The second communication system 22 has a second interaction interface 221 specific to the user 23. The intelligent communication secretary system 3 includes an intelligent interaction unit 31 and a database unit 32.

The first communication system 21 and the second communication system 22 are different communication services, have no common database, and do not exchange data. In some embodiments, the first communication system 21 is an internet-based server providing LINE communication services, and the second communication system 22 is a landline telephone system providing local telephone service. For example, the first communication system 21 and the second communication system 22 may alternatively employ other communication systems to provide communication services, including but not limited to Signal, Viber, Discord, Skype, Snapchat, Telegram, Facebook Messenger, WeChat and WhatsApp. The first interaction interface 211 and the second interaction interface 221 may be communication devices such as mobile phones, landline telephones, tablet devices, or computers equipped with a display, microphone, keyboard, and mouse.

The intelligent interaction unit 31 includes an intelligent interaction module 311 connected to the first interaction interface 211 and the second interaction interface 221, an interaction outline generation module 312 connected to the intelligent interaction module 311, an account comparison module 313 connected to the intelligent interaction module 311, a knowledge retrieval module 314 connected to the intelligent interaction module 311, a staff interaction module 315 connected to the intelligent interaction module 311, a knowledge augmentation module 316 connected to the intelligent interaction module 311, and a calendar editing module 317 connected to the intelligent interaction module 311.

The database unit 32 includes an account storage module 321 connected to the intelligent interaction module 311, a knowledge storage module 322 connected to the intelligent interaction module 311, a historical interaction storage module 323 connected to the intelligent interaction module 311, an outline data storage module 324 connected to the intelligent interaction module 311, and a calendar storage module 325 connected to the intelligent interaction module 311.

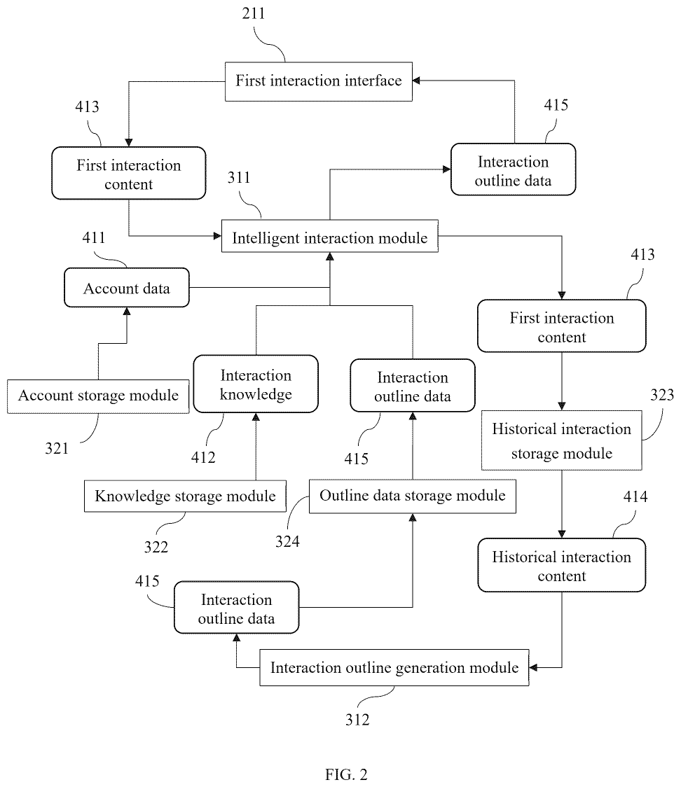

Referring to FIG. 1 and FIG. 2, in some embodiments, the intelligent communication secretary system 3 is a computer device applying smart software. The smart software may include, but is not limited to, ChatGPT, Simplified, Livelogue, Medium, Rationale, Large Language Model (LLM). The intelligent interaction unit 31 and the database unit 32 are computer control circuits equipped with a processor, memory, hard disk, and other storage components, as well as a network data transmitter. The intelligent interaction module 311, interaction outline generation module 312, account comparison module 313, knowledge retrieval module 314, staff interaction module 315, knowledge augmentation module 316, and calendar editing module 317 are applications installed in the intelligent interaction unit 31, and are respectively configured to enable the intelligent interaction unit 31 to perform data control functions. The account storage module 321, knowledge storage module 322, historical interaction storage module 323, outline data storage module 324, and calendar storage module 325 are applications installed in the database unit 32, and are respectively configured to enable the database unit 32 to perform data control functions. As the data processing technologies utilized by the intelligent communication secretary system 3 are consistent with those of conventional computers or computing devices, further elaboration is omitted.

The account storage module 321 is configured to store account data 411 related to the first interaction interface 211. The account data 411 has a friend relationship in the first communication system 21. The first interaction interface 211 may be a dialog window, a voice call, a video call, or the like in such a way that the intelligent interaction module 311 may interact with the user 23 by using the first interaction interface 211. The user 23 may be an enterprise customer, and may also be an enterprise staff or an enterprise supervisor, but should not be limited thereto.

The knowledge storage module 322 is configured to store interaction knowledge 412 of interaction with the user 23 for the intelligent interaction module 311 to interact with the user 23 and generate a first interaction content 413. The intelligent interaction module 311 may understand the meaning of the user 23, whether it is voice, a short message, or body language in a video. The interaction knowledge 412 may be enterprise knowledge. For instance, an enterprise using the intelligent communication secretary system 3 is a bank. The interaction knowledge 412 may be data of each customer. After understanding the meaning of the user 23, the intelligent interaction module 311 interacts with the customer by using the interaction knowledge 412 and stores an interaction content as a first interaction content 413. The knowledge augmentation module 316 is configured to augment the interaction knowledge 412 in the knowledge storage module 322. The knowledge augmentation module 316 may store related data such as a text, a voice, a file, an audio and video, and a picture into the knowledge augmentation module 322 to make the same into the interaction knowledge 412 for the intelligent interaction module 311 interacting with others. For example, the knowledge augmentation module 316 may be implemented as a retrieval-augmented generation (RAG) database customized by an enterprise or company, enabling the intelligent interaction module 311 to provide domain-specific expertise or service information tailored to that enterprise or company.

The historical interaction storage module 323 is configured to store the first interaction content 413 and make the same into a historical interaction content 414. The interaction outline generation module 312 analyzes the semantics of the historical interaction content 414 and generates interaction outline data 415 based on key semantic points, which is stored in the outline data storage module 324. The user 23 inputs information into the intelligent interaction unit 31 via the first interaction interface 211. The intelligent interaction module 311 interprets the information entered by the user 23, and retrieves relevant data from the database unit 3 based on the interpretation. The intelligent interaction module 311 then transmits the retrieval result back to the user 23 through the first communication system 21. When the user 23 is required to provide outline data, or after the intelligent interaction module 311 has finished a conversation with the user 23, the interaction outline generation module 312 analyzes the historical interaction content 414 to organize key points of the conversation and make the same into the interaction outline data 415. The interaction outline data 415 may be provided for the user 23 from the first interaction interface 211. The enterprise staff may also obtain the required interaction outline data 415 from the outline data storage module 324.

In addition, the first interaction interface 211 may also allow the enterprise staff to interact with the customer or multiple enterprise staffs have a meeting in the first interaction interface 211, just like a short message or video provided by current communication services, except that the intelligent interaction module 311 will capture the first interaction content 413 in the first interaction interface 211, such that the enterprise staff may use the interaction outline generation module 312 to obtain a summary of key points of the conversation or meeting, a detailed verbatim transcript of the process, and audio clips corresponding thereto at any time after the conversation or meeting to facilitate subsequent quick retrieval of related information records.

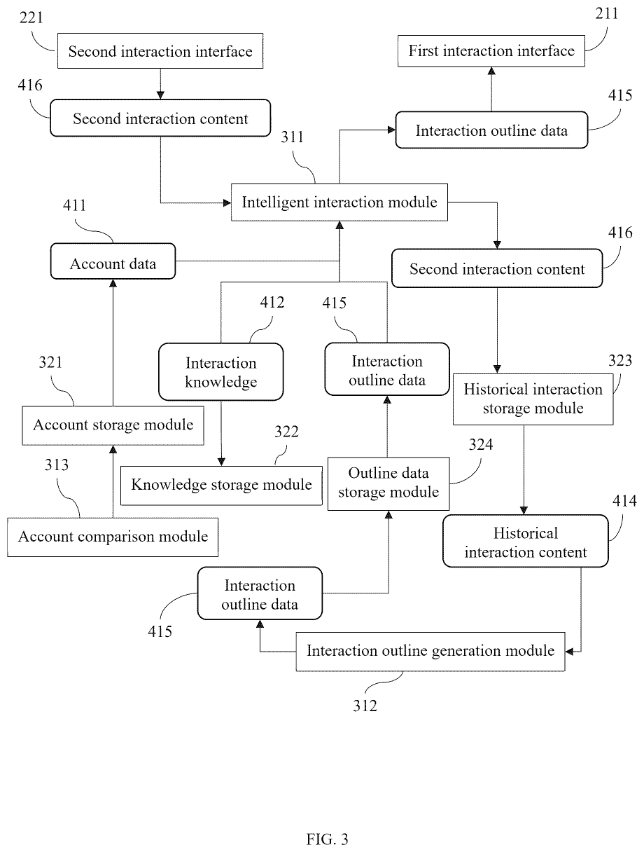

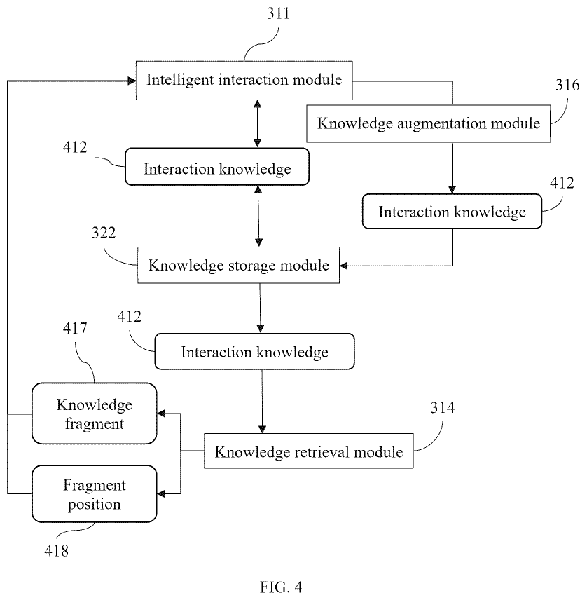

Referring to FIG. 1, FIG. 3 and FIG. 4, in some embodiments, when the user 23 uses the first interaction interface 211 to have a voice conversation with others or have a video meeting with multiple persons, the intelligent interaction module 311 will capture the first interaction content 413 in the first interaction interface 211 and store the same in the historical interaction storage module 323. The knowledge retrieval module 314 may convert a voice content or an audio and video content into a text content and store the same in the historical interaction storage module 323 to obtain a detailed verbatim transcript of the corresponding voice conversation or video meeting. In addition, the knowledge retrieval module 314 may more analyze the text content to classify the same and obtain a knowledge fragment 417 and a fragment position 418, and the fragment position 418 is playback time of the voice content or the audio and video content, which enables the stored detailed verbatim transcript to correspond to a clip of the audio or video, such that the user 23 may use the detailed verbatim transcript to quickly retrieve records such as related information, voice, audio and video.

The intelligent interaction module 311 is connected to the second communication system 22. The account comparison module 313 obtains a comparison account from the second communication system 22 and accesses to the account storage module 321 for retrieval to confirm whether the first communication system 21 has the account data 411 of the user 23 of the second communication 22. In some embodiments, the comparison account may be an ID number or telephone number of the customer, but should not be limited thereto. If the account storage module 321 has stored the account data 411, the account data 411 may be directly taken for use, and if the account comparison module 313 does not have the account data 411, the customer may be asked whether to provide them, in order to create new account data 411. In this way, the intelligent interaction module 311 is also enabled to interact with the user 23 via the second communication system 22. The user 23 inputs data through the second interaction interface 221, which transmits the data to the intelligent interaction module 311. The intelligent interaction module 311 interprets the semantics of the user 23 input and performs a retrieval from the database unit 32. The retrieval result is transmitted back to the user 23 via the second interaction interface 221.

The second communication system 22 interacts with the user 23 and generates a second interaction content 416. The historical interaction storage module 323 stores the second interaction content 416 and makes the same into a historical interaction content 414. The intelligent interaction module 311 outputs the interaction outline data 415 stored in the outline data storage module 324 from the first interaction interface 211 of the first communication system 21.

For instance, the second communication system 22 is a local telephone system. The second interaction interface 221 is a telephone. A customer uses the second interaction interface 221 to give a call to a customer service staff of a bank. After the customer service staff verifies basic data, the account data 411 of the corresponding customer stored in the account storage module 321 may be obtained. When the customer service staff answers a question of the customer, or when the customer sets a banking business, the historical interaction storage module 323 will store the second interaction content 416 in the second interaction interface 221. Since the second communication system 22 cannot provide a short message service, the intelligent interaction module 311 uses the account data 411 and transmits the interaction outline data 415 to the first interaction interface 211, such that the customer uses the second interaction interface 221 to converse with the customer service staff on enterprise matters and then obtain key points of the conversation with the enterprise from the first interaction interface 211. In other words, after the customer interacts with the enterprise using a telephone, the enterprise can utilize the intelligent system of the present disclosure to automatically reuse communication services such as LINE to provide results of related service contents (e.g., a picture, a video, a text, and a summary of a dialog content), thereby achieving a cross-platform interaction ability to further improve the customer service experience.

It is worth mentioning that an early interaction system can only provide a single mode. For instance, in a landline phone, after receiving a voice inquiry, a virtual customer service staff can only reply by a voice and cannot reply with a text, a picture or a video.

The intelligent interaction module 311 of the present disclosure can, based on the first interaction content 413 of the first interaction interface 211, control the knowledge retrieval module 314 to access to the knowledge storage module 322 or a network to retrieve the related text content, picture content, voice content and audio and video content and transmit the same to the second interaction interface 416. The intelligent interaction module 311 may also analyze the text content, the voice content, the picture content and the audio and video content and reply with a text, a voice, a picture and a video. Therefore, the intelligent interaction module 311 in conjunction with the knowledge retrieval module 314 can provide a multi-mode interaction technology.

For instance, when the customer uses the second communication system 22 (e.g., a landline phone or a mobile phone) to perform voice interaction with the customer service staff, the intelligent interaction module 311 first obtains an account of the first communication system 21 (e.g., LINE communication software) based on the basic data (e.g., a telephone number and identity data) of the customer, and may use the first interaction interface 211 to interact with the customer through a text, a file, a picture and a video after link building, where a dialog record or a content outline of the second communication system 22 may be presented in the first interaction interface 211 using a text, and may also be supplemented with related data such as a text, a picture and a video.

In addition, the intelligent interaction module 311 may not only control the knowledge retrieval module 314 to access to the knowledge storage module 322 to retrieve data, but also directly retrieve related data such as a text, a voice, a file, a picture and a video, or a link in a network system and upload the data or the link, such that the customer can view the contents such as the text, the voice, the picture and the video from the first interaction interface 211, or the customer service staff is provided with more appropriate data to interact with the customer. In other words, the intelligent communication secretary system 3 can provide the customer with the use of the data related to voice retrieval, such as a video, a picture and a text.

The knowledge retrieval module 314 may directly retrieve data in a knowledge base such as a text, a voice, a file, a picture and a video. Furthermore, the retrieved data are stored, and the stored data may be directly obtained the next time the same question is encountered. Therefore, the intelligent interaction module 311 has the ability to retrieve data without the need for deep learning.

In some embodiments, the second communication system 22 may also use other communication services or is the same as the first communication system 21, but should not be limited thereto. For instance, the user 23 may communicate with customer service using sign language through the video-enabled second interaction interface 221. The intelligent interaction module 311 analyzes the video to obtain the meaning of the conversation between the two parties and stores the same as the textual historical interaction content 414. After the interaction outline generation module 312 generates the interaction outline data 415, the interaction outline data 415 may be output to the first interaction interface 211 using text information.

In addition, the intelligent interaction module 311 can also provide the enterprise as a virtual customer service staff. The intelligent interaction module 311 is connected to the second interaction interface 221. The intelligent interaction module 311 interacts with the user 23 using the interaction knowledge 412 stored in the knowledge storage module 322. The interaction knowledge 412 has a feature of sign language response. The second interaction interface 221 is a video interface. The user 23 may have a physical conversation with the intelligent interaction module 311, which compiles the internation into the textual interaction outline data 415 and output the same from the first interaction interface 211.

Referring to FIG. 1 and FIG. 4, the interaction knowledge 412 stored in the knowledge storage module 322 is selected from one or a combination of a text content, a picture content, a voice content and a video content. When the enterprise staff needs to obtain related reference data in a conversation with the customer or in a meeting of a company, a request may be made for the intelligent interaction module 311. The knowledge retrieval module 314 automatically accesses to the knowledge storage module 322 to obtain the related interaction knowledge 412 for the enterprise staff, such that the intelligent communication secretary system 3 becomes a virtual secretary for the enterprise staff, or even for the enterprise supervisor.

The knowledge retrieval module 314 analyzes the interaction knowledge 412 stored in the knowledge storage module 322 to interpret the semantics of the interaction knowledge 412. Based on at least one keyword, the knowledge retrieval module 314 obtains at least one knowledge fragment 417 in the interaction knowledge 412 and at least one fragment position 418 for retrieving the knowledge fragment 417. The fragment position 418 is configured to provide the intelligent interaction module 311 with quick obtaining of the knowledge fragment 417. For instance, company regulations or related articles are added or updated in the knowledge storage module 322, the knowledge retrieval module 314 will analyze the stored interaction knowledge 412 to obtain related key points and positions of key contents. For example, if the keyword ‘seniority’ is used, the knowledge retrieval module 314 may retrieve the corresponding knowledge fragment 417 related to seniority along with its fragment position 418. When the intelligent interaction module 311 needs the related interaction knowledge 412, the fragment position 418 of the interaction knowledge 412 and the knowledge fragment 417 may be obtained through the knowledge retrieval module 314. In some embodiments, the knowledge retrieval module 314 may utilize other keywords to retrieve the knowledge fragment 417 and fragment position 418, and is not limited to the examples described above.

When the interaction knowledge 412 stored in the knowledge storage module 322 is a voice content or an audio and video content, the knowledge retrieval module 314 converts the voice content or the audio and video content into a text content first and then analyzes the text content to classify the same and obtain a knowledge fragment 417 and a fragment position 418. The fragment position 418 is playback time of the voice content or the audio and video content. When the enterprise staff or the intelligent interaction module 311 is required to provide the knowledge fragment 417 of the audio and the video, the knowledge fragment 417 may be quickly obtained by using the fragment position 418 and provided for the enterprise staff or the customer.

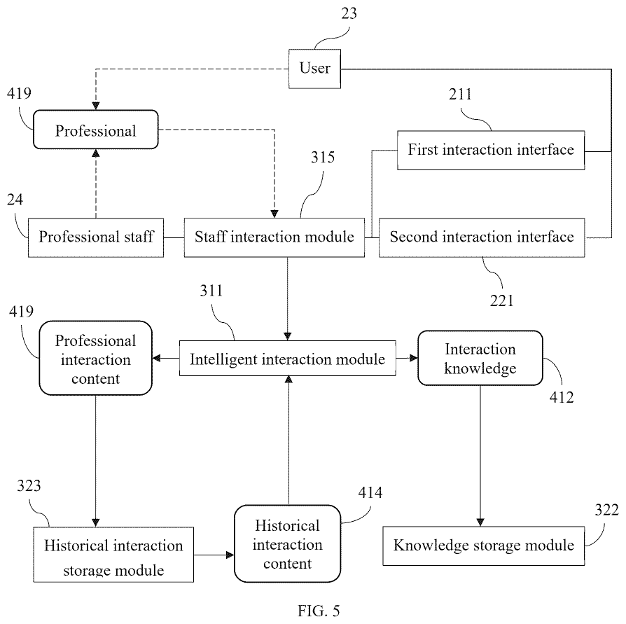

Referring to FIG. 1 and FIG. 5, the staff interaction module 315 provides a professional staff 24 to interact with the user 23 and generates a professional interaction content 419. The intelligent interaction module 311 stores the professional interaction content 419 in the historical interaction storage module 323 and makes the same into a historical interaction content 414. The intelligent interaction module 311 learns and analyzes the historical interaction content 414 and generates interaction knowledge 412 stored in the knowledge storage module 322. For instance, the professional staff 24 may be a professional customer service staff in a bank, but should not be limited thereto. Since the professional customer service staff may provide the professional interaction content 419, the degree of satisfaction of the customer can be greatly increased. The intelligent interaction module 311 may learn the professional interaction content 419 to confirm the identity of the customer to perform customer services such as reading data stored in the bank, such that the correspondence of the intelligent interaction module 311 may be comparable to that of the professional customer service staff, thereby achieving a service secretary of the enterprise.

In some embodiments, when the intelligent communication secretary system 3 starts to be established, the professional interaction content 419 has not been stored in the historical interaction storage module 323, and thus the intelligent interaction module 311 is not yet capable of performing interaction of professional knowledge. In this case, the intelligent interaction module 311 first becomes a role of an apprentice, with the goal of learning the professional knowledge.

For example, when the professional staff 24 performs customer services to provide the user 23 with a general reply or professional knowledge, the intelligent interaction module 311 monitors an interaction content of the two parties and analyzes the same to obtain the professional knowledge and establish the professional interaction content 419 stored in the historical interaction storage module 323, thereby increasing professional background knowledge of the intelligent interaction module 311.

After the intelligent interaction module 311 has learned for a period of time, the professional interaction content 419 stored in the historical interaction storage module 323 has been sufficient to make the intelligent interaction module 311 serve as an auxiliary tool for the customer service staff to provide the professional knowledge for a junior general customer service staff and enable the general customer service staff to provide customer services that are comparable to those of the professional staff 24. The intelligent interaction module 311 can even independently become a professional virtual customer service staff to directly perform interaction of customer services with the user 23.

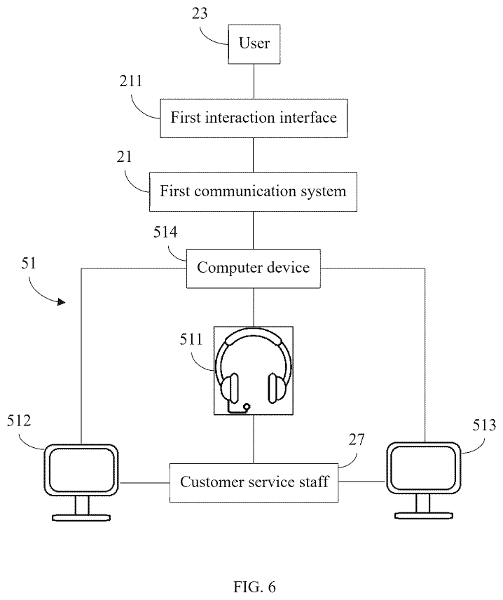

For instance, referring to FIG. 6, in a service interface 51 of the general customer service staff 27, a communication device 511, a first screen device 512, a second screen device 513, and a computer device 514 respectively connected to the communication device 511, the first screen device 512 and the second screen device 513 may be used. The intelligent communication secretary system 3 is provided in the computer device 514. The intelligent interaction module 311 can transmit data with the communication device 511, the first screen device 512 and the second screen device 513.

The computer device 514 is connected to the first communication system 21, such that the customer service staff 27 makes a voice call with the user 23 (the customer) by using the communication device 511. The first screen device 512 provides the customer service staff 27 with the inquiry of basic data of the user 23. The intelligent interaction module 311 in the computer device 514 may monitor a dialog content of the communication device 511 and a content display by the computer device 514 on the first screen device 512 into the historical interaction storage module 323 or onto a network for data retrieval, and display the retrieved professional interaction content 419 or other information onto the second screen device 513. The customer service staff 27 can provide a service content that is comparable to that of the professional customer service staff based on a content on the second screen device 513.

In some embodiments, the intelligent communication secretary system 3 can further be used in a tour guide robot, e.g., a fixed-point or mobile tour guide robot in a museum, but should not be limited thereto. The intelligent communication secretary system 3 can be connected to a mobile phone of a visitor to use communication software or other programs to interact with the tour guide robot. When the visitor asks the tour guide robot about a position of a dressing room by using a voice, the intelligent communication secretary system 3 may understand the meaning behind the visitor's inquiry to present a retrieved map or navigation onto the mobile phone of the visitor.

Additionally, the visitor may also directly ask about an introduction of an exhibit on the mobile phone through a text or a voice. After understanding the meaning behind the visitor's inquiry, the intelligent communication secretary system 3 accesses to a related database or network for retrieval and then displays the retrieved introduction of the exhibit on the tour guide robot or the mobile phone of the visitor in a form of a text, a picture, a video, etc.

In some embodiments, the first communication system 21 is a smart mobile phone. After the smart mobile phone of the visitor is connected to a server of the intelligent communication secretary system 3, the visitor has a direct dialog with the smart mobile phone. The intelligent communication secretary system 3 directly understands the meaning behind the visitor's speech, retrieves data according to requests of the visitor, and uploads the retrieved data to the smart mobile phone of the visitor, such that the smart mobile phone of the visitor directly becomes the tour guide robot.

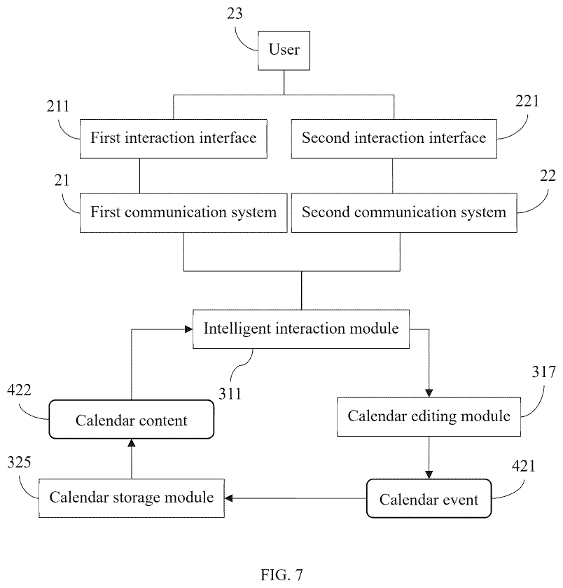

Referring to FIG. 1 and FIG. 7, the calendar editing module 317 analyzes data stored in the historical interaction storage module 323, extracts data related to a calendar and generates a calendar event 421. The intelligent interaction module 311 edits a calendar content 422 in the calendar storage module 325 based on the calendar event 421. Preferably, when the enterprise staff uses the first interaction interface 211 or the second interaction interface 221, the intelligent interaction unit 31 may be called to use the calendar editing module 317 to generate the calendar event 421. Or when the enterprise staff interacts with others and the first interaction content 413 and the second interaction content 416 are stored in the historical interaction storage module 323, the calendar editing module 317 analyzes the first interaction content 413 and the second interaction content 416 to judge whether there is the calendar event 421 in the contents and automatically make the calendar event 421 into the calendar content 422, and whether the calendar content 422 is to be generated may also be confirmed by asking, such that the data stored in the calendar storage module 325 can assist the enterprise in arranging a calendar of events as a basis for future actions. For instance, the user 23 has a video meeting in the first interaction interface 211 and mentions a calendar event 421 of encountering on an appointed day in the meeting, then the calendar editing module 317 will add a new calendar content 422 on the appointed day, which, in some embodiments, may be used in other calendar technologies, but should not be limited thereto.

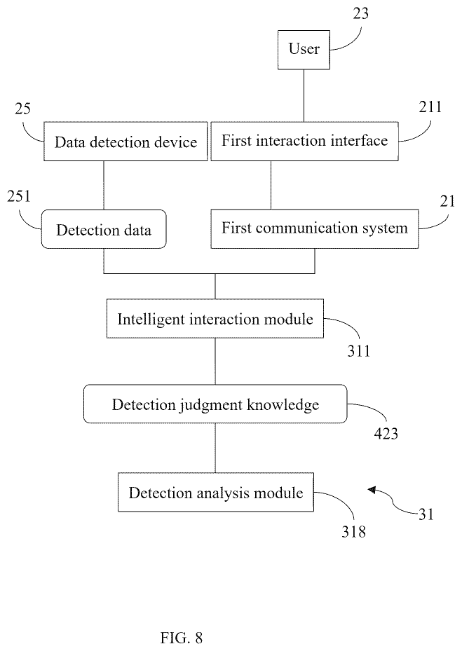

Referring to FIG. 8, the intelligent interaction module 311 is further connected to a data detection device 25 outputting detection data 251. The intelligent interaction unit 31 further includes a detection analysis module 318 connected to the intelligent interaction module 311. The detection analysis module 318 is an application installed in the intelligent interaction unit 31, configured to enable the intelligent interaction unit 31 to perform data control functions. The detection analysis module 318 stores detection judgment knowledge 423 and analyzes and judges the detection data 251. The intelligent interaction module 311 interacts with the user 23 in the first communication system 21 based on a judgment result of the detection analysis module 318. The data detection device 25 is a camera. In some embodiments, other detection devices may also be used as the data detection device 25, but should not be limited thereto.

The intelligent interaction module 311 becomes a virtual customer service staff to perform customer service interaction with the user 23. In the interaction process, it is difficult to answer a question of the user 23 by using stored knowledge, and it is necessary to analyze or judge an existing condition. In this case, an on-site condition is obtained by using the data detection device 25, analyzed by the detection analysis module 318 and judged to obtain a result, and then the judgment result of the on-site condition is provided for the user 23.

For instance, the intelligent communication secretary system 3 is a customer service system of a restaurant. When the user 23 asks the intelligent interaction module 311 about a reservation condition of the restaurant through the first communication system 21, the intelligent interaction module 311 cannot provide a customer service from existing stored data, and it is necessary to judge the on-site condition separately from the connected data detection device 25. The intelligent interaction module 311 transmits video data of the detection data 251 to the detection analysis module 318 for analysis. The detection analysis module 318 will analyze a usage condition of dining tables or dining time of guests to judge when there will be an empty table. Then the intelligent interaction module 311 provides waiting time and a reserved table for the user 23 to complete a procedure of restaurant reservation. In some embodiments, the intelligent interaction module 311 may further obtain historical data based on the account data 411 of the user 23 to provide data such as reserving approach time, reserving a table, a birthday discount, and a demand for a kid's meal.

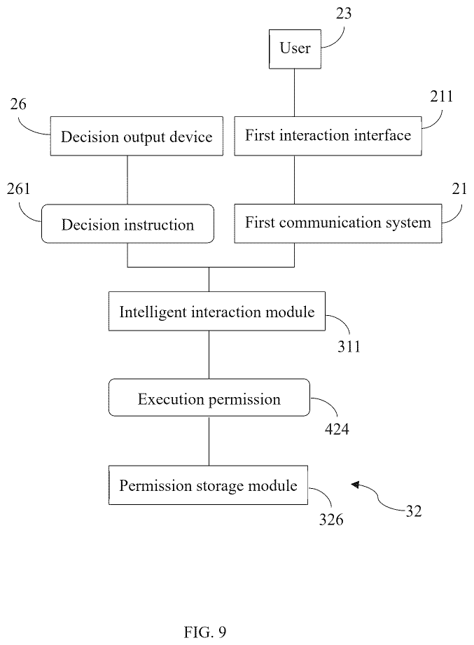

Referring to FIG. 9, the intelligent interaction module is further connected to a decision output device 26 for outputting a decision instruction 261. The database unit 32 further includes a permission storage module 326 connected to the intelligent interaction module 311. The permission storage module 326 is an application installed in the database unit 32, configured to enable the database unit 32 to perform data control functions. The permission storage module 326 is configured to store an execution permission 424 related to the decision instruction 261 and set the execution permission 424 of the decision instruction 261 as a priority in such a way that the intelligent interaction module 311 prioritizes execution of the decision instruction 261. In some embodiments, the decision output device 26 is a communication device of a supervisor or a field staff, but should not be limited thereto.

For instance, the intelligent interaction module 311 is a virtual customer service staff. The supervisor uses the decision output device 26 to monitor a content between the user 23 and the intelligent interaction module 311 during work. In the execution permission 424, the decision instruction 261 is prioritized, and intelligent analysis of the intelligent interaction module 311 is secondary. When the user 23 has a voice conversation with the intelligent interaction module 311 and asks about the reservation condition of the restaurant, the supervisor directly judges based on the on-site condition and issues a decision instruction 261 of “there will be a seat available in 20 minutes” to the intelligent interaction module 311. The intelligent interaction module 311 prioritizes analysis of a content of the decision instruction 261 based on the execution permission 424 of the permission storage module 326 and provides a customer service reply of “there will be a seat available in 20 minutes. May I ask if you need to reserve a seat” to the user 23. In some embodiments, the decision output device 26 can further output decision instructions 261, such as “no more guests”, “insufficient raw materials”, “Table 6 is empty”, and “The next group of guests can enter”, to the intelligent interaction module 311. In some embodiments, the decision output device 26 may also issue a decision instruction 261 of an outbreak of fire. The intelligent interaction module 311 will automatically judge based on the interaction knowledge 412 or the professional interaction content 419 and perform operations such as an alarm of the fire, remotely closing a fire door, and directing people to evacuate through a broadcasting system.

As can be seen from the above description, the intelligent communication secretary system 3 of the present disclosure indeed has the following features.

### 1. There is No Need to Manually Organize an Outline of Key Points.

The interaction outline generation module 312 may immediately analyze the meaning in the process of interaction or analyze the historical interaction content 414 after the completion of the interaction, in order to organize key points of the interaction and make them into the interaction outline data 415. The customer may quickly organize key points of a conversation with an enterprise from the interaction outline data 415. The enterprise staff may also immediately obtain key points discussed in a meeting from the interaction outline data 415. Therefore, the user 23 does not need to spend a lot of time in organizing the key points of the interaction.

### 2. Services for Accelerating Data Inquiry and Content Confirmation are Provided.

The knowledge retrieval module 314 may convert the first interaction content 413 into a corresponding detailed verbatim transcript, and may also analyze the detailed verbatim transcript to classify the same and obtain the corresponding knowledge fragment 417 and fragment position 418, in order to obtain fragmented video file records corresponding to the detailed verbatim transcript. In addition, a general summary of key points may also be obtained from the above interaction outline data 415, which may quickly trace actually recorded contents of the original detailed verbatim transcript and the fragmented video file records, thereby providing the effects of facilitating quick inquiry of data and confirmation of a conversation content.

### 3. The Required Data May be Quickly Obtained.

The knowledge retrieval module 314 analyzes the interaction knowledge 412 stored in the knowledge storage module 322 to obtain the knowledge fragment 417 in the interaction knowledge 412 and the fragment position 418 for retrieving the knowledge fragment 417, whether it is very long textual data or video data with very long playback time. The fragment position 418 may provide the intelligent interaction module 311 with quick obtaining of the knowledge fragment 417 in such a way that the intelligent interaction unit 31 quickly obtains the required data.

### 4. The Function of Cross-Platform Service is Achieved.

The account comparison module 313 obtains a comparison account from the second communication system 22 and accesses the account storage module 321 for retrieval to confirm whether the first communication system 21 has account data 411 of the user 23 of the second communication system 22. A result discussed in the second communication system 22 may be output from the first interaction interface 211, and an interaction result of the first interaction interface 211 may also be output from the second interaction interface 221 to achieve the function of cross-platform service. In addition, the intelligent interaction module 311 can more preferably use the second communication system 22 for a voice conversation and then use the first communication system 21 to provide related data such as a text, a voice, a file, a picture, and an audio and video and interact, in order to achieve a multi-mode interaction conversation.

5. Services of Professional Knowledge can Also be Provided by General Staffs without Professional Background Knowledge.

The intelligent interaction module 311 may first become a role of an apprentice to learn interaction and professional knowledge of an existing professional staff 24 and is used as an auxiliary tool for customer services, such that general staffs who are junior or have no professional background knowledge can also obtain professional knowledge in real time and perform customer services, and general customer service staffs can provide customer services that are comparable to those of the professional staff 24. The intelligent interaction module 311 can even also independently become a professional virtual customer service staff.

### 6. Customer Services can be Provided Based on an On-Site Condition.

The intelligent interaction module 311 may be connected to the external data detection device 25 in such a way that the intelligent interaction module 311 can obtain the on-site condition. The detection analysis module 318 analyzes and judges the on-site condition to obtain a result. Then the intelligent interaction module 311 interacts with a customer based on the judgment result and can provide customer services based on the on-site condition without the need for a staff to take over.

To sum up, the intelligent communication secretary system 3 is a computer system applying smart software and has a basis of basic interaction. The knowledge storage module 322 may provide enterprise-related professional knowledge to the intelligent interaction unit 31 for use. The intelligent interaction unit 31 may not only record a meeting result between people, but also serve as a virtual customer service staff to interact with a customer. The interaction outline data 415 generated by the interaction outline generation module 312 can provide key points of a customer service to the customer and may also provide key points of a meeting to an enterprise supervisor. The calendar editing module 317 may automatically generate the calendar content 422 based on a content of the interaction. Therefore, the objective of the present disclosure may be indeed achieved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. An intelligent communication secretary system, applicable to being connected to a first communication system, the first communication system having a first interaction interface specific to a user comprising:
an intelligent interaction unit comprising an intelligent interaction module connected to the first interaction interface and an interaction outline generation module connected to the intelligent interaction module;
a database unit comprising an account storage module connected to the intelligent interaction module, a knowledge storage module connected to the intelligent interaction module, a historical interaction storage module connected to the intelligent interaction module, and an outline data storage module connected to the intelligent interaction module, the account storage module being configured to store account data related to the first interaction interface in such a way that the intelligent interaction module is able to interact with the user by using the first interaction interface, the knowledge storage module being configured to store interaction knowledge of interaction with the user for the intelligent interaction module to interact with the user and generate a first interaction content, the historical interaction storage module being configured to store the first interaction content and make a same into a historical interaction content, and the interaction outline generation module analyzing the semantics of the historical interaction content and generating interaction outline data based on key semantic points, which is stored in the outline data storage module;
wherein the user inputs information into the intelligent interaction unit via the first interaction interface, the intelligent interaction module interprets the information entered by the user, retrieves relevant data from the database unit based on the interpretation, and the intelligent interaction module transmits the retrieval result back to the user through the first communication system.

2. The intelligent communication secretary system according to claim 1, wherein the intelligent communication secretary system is further connected to a second communication system, the intelligent interaction unit further comprises an account comparison module connected to the intelligent interaction module, the intelligent interaction module is connected to the second communication system, and the account comparison module obtains a comparison account from the second communication system and accesses to the account storage module for retrieval to confirm whether the first communication system has account data of a user of the second communication system, thereby enabling the intelligent interaction module to interact with the user via the second communication system.

3. The intelligent communication secretary system according to claim 2, wherein the second communication system interacts with the user and generates a second interaction content, the historical interaction storage module stores the second interaction content and makes a same into a historical interaction content, and the intelligent interaction module outputs the interaction outline data stored in the outline data storage module from the first interaction interface of the first communication system.

4. The intelligent communication secretary system according to claim 2, wherein the second communication system has a second interaction interface, the intelligent interaction module is connected to the second interaction interface, the intelligent interaction module uses the interaction knowledge stored in the knowledge storage module to interact with the user, the user inputs data through the second interaction interface, which transmits the data to the intelligent interaction module, the intelligent interaction module interprets the user's semantics and performs a retrieval from the database unit, and the retrieval result is transmitted back to the user via the second interaction interface.

5. The intelligent communication secretary system according to claim 4, wherein the intelligent interaction unit further comprises a knowledge retrieval module connected to the intelligent interaction module, the knowledge retrieval module stores at least one keyword, which is used to analyze the interaction knowledge stored in the knowledge storage module to obtain at least one knowledge fragment in the interaction knowledge and at least one fragment position for retrieving the knowledge fragment, and the fragment position is used for the intelligent interaction module to quickly obtain the knowledge fragment.

6. The intelligent communication secretary system according to claim 5, wherein the interaction knowledge stored in the knowledge storage module is selected from one or a combination of a text content, a picture content, a voice content and an audio and video content, and the intelligent interaction module, based on the first interaction content of the first interaction interface, controls the knowledge retrieval module to access to the knowledge storage module or a network to retrieve the related text content, picture content, voice content and audio and video content and transmit a same to the second interaction interface.

7. The intelligent communication secretary system according to claim 6, wherein in a case that the interaction knowledge stored in the knowledge storage module is the voice content or the audio and video content, the knowledge retrieval module converts the voice content or the audio and video content into the text content first and then analyzes the text content to classify a same and obtain a knowledge fragment and a fragment position, and the fragment position is playback time of the voice content or the audio and video content.

8. The intelligent communication secretary system according to claim 1, wherein the intelligent interaction unit further comprises a staff interaction module connected to the intelligent interaction module, the staff interaction module provides a professional staff to interact with the user and generates a professional interaction content, the intelligent interaction module stores the professional interaction content in the historical interaction storage module and makes a same into a historical interaction content, and the intelligent interaction module learns and analyzes the historical interaction content and generates interaction knowledge stored in the knowledge storage module.

9. The intelligent communication secretary system according to claim 1, wherein the intelligent interaction unit further comprises a knowledge augmentation module connected to the intelligent interaction module, and the knowledge augmentation module is configured to augment the interaction knowledge in the knowledge augmentation module.

10. The intelligent communication secretary system according to claim 1, wherein the intelligent interaction unit further comprises a calendar editing module connected to the intelligent interaction module, the database unit further comprises a calendar storage module connected to the intelligent interaction module, the calendar editing module analyzes data stored in the historical interaction storage module, extracts data related to a calendar and generates a calendar event, and the intelligent interaction module edits a calendar content in the calendar storage module based on the calendar event.

11. The intelligent communication secretary system according to claim 1, wherein the intelligent interaction module is further connected to a data detection device outputting detection data, the intelligent interaction unit further comprises a detection analysis module connected to the intelligent interaction module, the detection analysis module stores detection judgment knowledge and analyzes and judges the detection data, and the intelligent interaction module interacts with the user in the first communication system based on a judgment result of the detection analysis module.

12. The intelligent communication secretary system according to claim 1, wherein the intelligent interaction module is further connected to a decision output device for outputting a decision instruction, the database unit further comprises a permission storage module connected to the intelligent interaction module, and the permission storage module is configured to store an execution permission related to the decision instruction and set the execution permission of the decision instruction as a priority in such a way that the intelligent interaction module prioritizes execution of the decision instruction.
